(19) United States
(12) Patent Application Publication
(10) Pub. No.: US 2023/0383708 A1
(43) Pub. Date: Nov. 30, 2023

(54) PISTON FOR AN INTERNAL COMBUSTION ENGINE, INTERNAL COMBUSTION ENGINE HAVING A PISTON

(71) Applicant: FEDERAL -MOGUL NURNBERG GMBH, NURNBERG (DE)

(72) Inventors: THOMAS KIRSTE, BURGTHANN (DE); ROMAN MORGENSTERN, HEILSBRONN (DE); ROBERT WILLARD, NURNBERG (DE); MARTIN POPP, NURNBERG (DE); THOMAS HUTZLER, HERZOGENAURACH (DE); ANDREAS HORAUF, STEIN (DE); PHILIPP KOCH, NURNBERG (DE)

(21) Appl. No.: 18/044,508

(22) PCT Filed: Sep. 8, 2021
(86) PCT No.: PCT/EP2021/074659

§ 371 Date: Mar. 8, 2023

(30) Foreign Application Priority Data
Sep. 8, 2020 (DE) 10 2020 211 246.0

(51) Int. Cl. F02F 3/00; C22C 38/48; C22C 38/46; C22C 38/44; C22C 38/42; C22C 38/06; C22C 38/04; C22C 38/02; C22C 38/00

(52) U.S. Cl. CPC F02F 3/0084; C22C 38/48; C22C 38/46; C22C 38/44; C22C 38/42; C22C 38/06; C22C 38/04; C22C 38/02; C22C 38/002; C22C 38/001

(57) ABSTRACT

A piston for an internal combustion engine, in particular for a diesel engine, comprises an iron-based alloy having the following alloy elements in percent by weight (wt %):
Carbon (C): 0.07 to 0.24;
Chromium (Cr): >7.0 to 12.5;
Molybdenum (Mo): 0.3 to 1.2;
Manganese (Mn): 0.3 to 0.9;
Silicon (Si): <0.5;
Copper (Cu): <0.3;
Nickel (Ni): <0.8;
Vanadium (V): 0.15 to 0.35;
Sulfur (S): <0.015;
Phosphorus (P): <0.025;
Niobium (Nb): <0.1;
Nitrogen (N): <0.07;
Aluminum (Al): <0.04;
Tungsten (W): <2.5
and the remainder being iron (Fe) and unavoidable impurities. Further included is the use of such an iron-based alloy for pistons of an internal combustion engine, in particular of a diesel engine.

### BACKGROUND

### 1. Technical Field

The present invention relates to a piston for an internal combustion engine as well as an internal combustion engine having such a piston and the use of an iron-based alloy for pistons of an internal combustion engine.

### 2. Related Art

Driven by the economic and ecological demand for consumption- and emission-optimized means of transport, a rapid development of increasingly higher performance and lower emission internal combustion engines has succeeded in the last 20 years. A decisive key for this continuous progress is engine pistons that can be used at increasingly higher combustion temperatures and pressures, but still have a low weight or total weight of the piston group (pistons, rings, pins and, where applicable, connecting rods). This is essentially made possible by the development of higher performance piston materials.

Another very important step of change in this regard is the switch from aluminum to steel engine pistons, especially for diesel engine pistons. Despite the higher density and poorer heat conductivity of the steel material, its advantages such as higher strength and higher maximum operating temperature can be used advantageously. To date, for the most part, low-alloy and very inexpensive steels of the type 42CrMo4 and 38MnVS6 have been used for steel pistons. However, their range of use is limited and already reaches its limits in current developments. In this regard, above all the comparatively low oxidation resistance (oxidation=scaling or high-temperature corrosion) plays a decisive role.

It is well known that alloy elements in steel are decisive for the formation of the properties, and this is used in the above-mentioned conventional steels. The addition of chromium causes an increase in oxidation resistance, an increase in strength, a reduction in heat conductivity but also an increase in material costs. The addition of molybdenum causes an increase in oxidation resistance, an increase in high temperature strength but also an increase in material costs. The addition of vanadium causes an increase in high temperature strength but also an increase in material costs. The addition of niobium causes grain refinement, the formation of carbides and nitrides, and a reduction in toughness and again an increase in material costs. The same holds true for the addition of tungsten, which additionally causes an increase in high temperature strength.

### SUMMARY

A piston for an internal combustion engine comprises an iron-based or steel alloy which ideally combines the following and transfers it to the piston in a positive manner:
higher oxidation resistance as compared to the steel materials used to date;
sufficient strength for the intended use at high temperatures under TMF stress (“Thermo Mechanical Fatigue”=“TMF”), i.e. sufficient thermomechanical fatigue strength;
sufficient isothermal fatigue strength (“High Cycle Fatigue”=“HCF”) for the intended use;
good weldability, especially for induction welding and friction welding, and generally good machinability;
sufficient heat conductivity for the intended use; and
a limited increase in material and processing costs.

### DETAILED DESCRIPTION

A piston for an internal combustion engine, preferably a diesel engine, comprises an iron-based alloy or consisting thereof as the piston material, having the following alloy elements in weight percent (% by weight or “wt. %”):

Carbon (C):
including 0.07 up to and including 0.24;

Chromium (Cr):
>7.0 up to and including 12.5;

Molybdenum (Mo):
including 0.3 up to and including 1.2;

Manganese (Mn):
including 0.3 up to and including 0.9;

Silicon (Si):
<0.5;

Copper (Cu):
<0.3;

Nickel (Ni):
<0.8;

Vanadium (V):
including 0.15 up to and including 0.35;

Sulfur (S):
<0.015;

Phosphorus (P):
<0.025;

Niobium (Nb):
<0.1;

Nitrogen (N):
<0.07;

Aluminum (Al):
<0.04;

Tungsten (W):
<2.5

and the remainder being iron (Fe) and unavoidable impurities, wherein optionally all other elements contained are <0.01 wt. % each.

The iron-based alloy according to the invention can preferably be characterized or designated as a high-alloy steel and further preferably as a tempering steel. To increase and improve the high-temperature properties, the contents of relevant alloy elements were further increased. The iron-based alloy of the piston is characterized in particular by the alloy elements chromium, molybdenum, tungsten, niobium and vanadium, which are used in greatly increased amounts compared to the previous 42CrMo4 and 38MnVS6-series alloys in order to achieve improved oxidation resistance and sufficient high-temperature (fatigue) strength. In particular, the chromium content is advantageously selected comparatively high.

Although significantly higher proportions of these elements would be possible in steels, they were deliberately limited to optimize weldability, machinability, costs, and heat conductivity for manufacturing and application. The piston material according to the invention thus represents an iron-based alloy or a steel which has an increased oxidation resistance and sufficient strength at high temperatures and under TMF stress. The piston material is nevertheless still easily weldable (e.g. by induction welding, friction welding and/or laser welding) and machinable. In addition, the heat conductivity is not yet too low and in the usable range. The material costs are nevertheless within an acceptable range. The piston according to the invention represents an optimal compromise between material properties and material costs, especially when it comes to optimized oxidation resistance at high temperatures.

Advantageously, the iron-based alloy can further comprise in percent by weight (wt. %):

Chromium (Cr):
including 9.0 up to and including 12.0 and/or

Molybdenum (Mo):
including 0.8 up to and including 1.1.

These ranges are to be understood as preferred subranges of the above-defined broader content ranges, in which the technical effects and advantages of the present invention are particularly prominent. Within the scope of the present invention, the preferred subranges can be combined with the broader content ranges and with each other as desired, and arbitrary new content ranges can be created from the upper content limits and lower content limits.

It is particularly preferred that the iron-based alloy is a steel of the type X10CrMoVNb9-1 or X22CrMoV12-1, i.e. consists of these. These steels are readily available and can be used directly to produce the piston according to the invention with its positive properties.

Advantageously, the iron-based alloy of the piston according to the invention is a heat-treated alloy having or consisting of at least a tempering microstructure, preferably tempered martensite and/or an intermediate microstructure, preferably bainite, and optionally having a ferrite content of ≤10% in the microstructure. It is preferred for the alloy to comprise, or consist of, one or more of the above microstructure types. Furthermore, it is preferred that the alloy according to the invention is a tempering steel produced by tempering, i.e. a combination of hardening and subsequent annealing or optionally austempering. The present carbide formers Cr, Mo and V significantly change the formation mechanism of carbides formed during annealing. At annealing temperatures up to about 400° C., predominantly Fe₃C precipitates are generated even in alloyed tempering steels. Above 400° C. to 450° C., the diffusivity of the carbide formers increases to such an extent that alloyed carbides can be formed which are thermodynamically much more stable (special carbides). Fe₃C already present is dissolved in favor of the more stable special carbides. Processes of special carbide formation during annealing of alloyed steels are often also referred to as fourth annealing stage. Thus, the advantages of annealing resistant tempering steels are the significantly lower diffusivity of the carbide formers, which shifts the special carbide formation, i.e. the decrease in strength, to higher temperatures and longer times. Moreover, the precipitated special carbides are considerably finer than the iron carbides, which results in an additional strength increase. The heat treatment (tempering) according to the invention allows achieving a particularly important combination of properties, namely a still sufficient yield strength combined with a high ductility, e.g. the notch impact strength, which is important for brittle fracture resistance. Therefore, annealing of the tempering microstructure is performed at a minimum of 400° C.

Another aspect of the present invention is an internal combustion engine, in particular a diesel engine, having a piston according to the embodiments described so far. The piston according to the invention transfers all its technical advantages to the internal combustion engine which contains the piston as a component.

The present invention further comprises the use of the previously defined iron-based alloy in all of its embodiments, preferably in the form of the above steels of the type X10CrMoVNb9-1 or X22CrMoV12-1, for pistons of an internal combustion engine, in particular a diesel engine.

What is claimed is:

1-8. (canceled)

9. A piston for an internal combustion engine, comprising an iron-based alloy having the following alloy elements in percent by weight (wt. %):
Carbon (C): 0.07 to 0.24;
Chromium (Cr): >7.0 to 12.5;
Molybdenum (Mo): 0.3 to 1.2;
Manganese (Mn): 0.3 to 0.9;
Silicon (Si): <0.5;
Copper (Cu): <0.3;
Nickel (Ni): <0.8;
Vanadium (V): 0.15 to 0.35;
Sulfur (S): <0.015;
Phosphorus (P): <0.025;
Niobium (Nb): <0.1;
Nitrogen (N): <0.07;
Aluminum (Al): <0.04;
Tungsten (W): <2.5
and the remainder being iron (Fe) and unavoidable impurities.

10. The piston according to claim 9, wherein
the iron-based alloy comprises in percent by weight (wt. %):
Chromium (Cr): 9.0 to 12.0 and/or
Molybdenum (Mo): 0.8 to 1.1.

11. The piston according to claim 9, wherein
the iron-based allow is a steel of the type X10CrMoVNb9-1 or X22CrMoV12-1.

12. The piston according to claim 9, wherein
the iron-based alloy is a heat-treated alloy comprising at least a tempering
microstructure and/or an intermediate microstructure.

13. An internal combustion engine having a piston according to claim 9.

14. The piston according to claim 12, wherein the heat treat alloy has a ferrite content of ≤10% in the microstructure.
